(19) United States
(12) Patent Application Publication
(10) Pub. No.: US 2024/0071347 A1
(43) Pub. Date: Feb. 29, 2024

(54) VOLUME CONTROL DEVICE, ELECTRONIC MUSICAL INSTRUMENT, VOLUME CONTROL METHOD, AND NON-TRANSITORY RECORDING MEDIUM

(71) Applicant: CASIO COMPUTER CO., LTD., Tokyo (JP)

(72) Inventor: Hiroki SATO, Tokyo (JP)

(73) Assignee: CASIO COMPUTER CO., LTD., Tokyo (JP)

(21) Appl. No.: 18/456,076

(22) Filed: Aug. 25, 2023

(30) Foreign Application Priority Data
Aug. 26, 2022 (JP) 2022-134864

(51) Int. Cl. G10H 1/46; G10H 1/00

(52) U.S. Cl. CPC G10H 1/46; G10H 1/0008; G10H 2210/031; G10H 2210/265

(57) ABSTRACT

A volume control device includes at least one information processor configured to: acquire a sound setting related to a sound output based on sound source information; and generate a sound output signal from the acquired sound source information on the basis of the sound setting, in which the sound setting includes a volume setting that defines a volume and a correction setting related to a correction amount of the volume according to a volume feeling of the sound setting, and the information processor is further configured to correct the volume defined in the volume setting with the correction amount to generate the sound output signal.

### REFERENCE TO RELATED APPLICATIONS

The present application claims priority based on Japanese Patent Application No. 2022-134864 filed on Aug. 26, 2022, the entire contents of which are incorporated herein.

### BACKGROUND

### 1. Technical Field

The present disclosure relates to a volume control device, an electronic musical instrument, a volume control method, and a non-transitory recording medium.

### 2. Related Art

Electronic musical instruments can output sound with various tones and volumes for performance operations of users. Setting of the tone, volume, and performance effect (effect) is not only individually operated by a switch or the like, but also performed by selecting a sound setting called a preset patch or the like from a combination of the tone, volume, and performance effect and applying the selected sound setting to the performance. The user can easily and quickly change an output of the performance of the electronic musical instrument among desired tones by switching the patch for each scene related to a combination of a live venue, a musical piece, a scene in the musical piece, and the like.

In addition, the electronic musical instrument can also output sound by integrating a musical sound related to performance of the electronic instrument and sound data input from an outside, for example, performance of another person or performance data recorded in advance. If the volume setting or the like of the musical sound to be combined at this time is different, there may be a case where some sound is large and another sound is difficult to be effective. In the technique of JP 2007-298751 A, in a case where singer's voice is input from the outside, the input is detected at a stage of voice data, and the volume and the like are relatively adjusted before the voice is actually output.

### SUMMARY

A volume control device includes at least one information processor configured to: acquire a sound setting related to a sound output based on sound source information; and generate a sound output signal from the acquired sound source information on the basis of the sound setting, in which the sound setting includes a volume setting that defines a volume and a correction setting related to a correction amount of the volume according to a volume feeling of the sound setting, and the information processor is further configured to correct the volume defined in the volume setting with the correction amount to generate the sound output signal.

### BRIEF DESCRIPTION OF THE DRAWINGS

The present disclosure will be more understood with reference to the following detailed descriptions with the accompanying drawings:

FIG. 1 is a plan view of an upper surface of a multi-effector;

FIG. 2 is a block diagram illustrating a functional configuration of the multi-effector;

FIG. 3 is a diagram for describing a flow of signals in a DSP and its surroundings;

FIG. 4 is a table illustrating an example of setting content related to patch effects;

FIG. 5A is a graph illustrating a relationship between a volume set value and amplitude, and FIG. 5B is a graph illustrating an example of an input/output relationship in a guitar amplifier;

FIG. 6 is a flowchart illustrating a control procedure of sound output control processing;

FIG. 7 is a flowchart illustrating a control procedure of volume correction processing;

FIG. 8 is a plan view illustrating an upper surface of an electronic musical instrument;

FIG. 9 is a block diagram illustrating a functional configuration of the electronic musical instrument; and

FIG. 10 is a diagram for describing a flow of signals in the electronic musical instrument.

### DETAILED DESCRIPTION

For example, as in JP 2007-298751 A described above, there is a problem that even if similar volume setting is performed, the sound output may not be heard at an appropriate volume in terms of audibility due to differences in various parameters related to sound setting.

The present disclosure enables easy output sound with a more appropriate volume.

Hereinafter, embodiments of the present disclosure will be described with reference to the drawings.

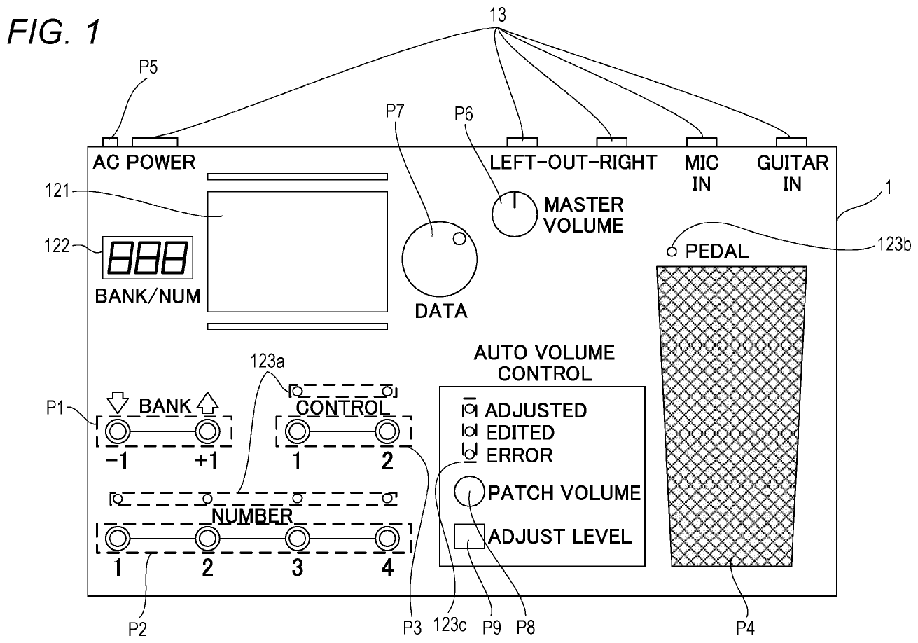

FIG. 1 is a plan view of an upper surface (operation surface) of a multi-effector 1 including a volume control device according to a first embodiment.

The multi-effector 1 of the present embodiment receives an input of performance data (sound source information) of an electronic musical instrument and adjusts sound of when performing sound output according to the performance data. The multi-effector 1 allows a user who is a player of the electronic musical instrument to switch an effect related to performance output of the electronic musical instrument with a foot. The electronic musical instrument is not particularly limited, but is, for example, a guitar here. The multi-effector 1 includes an operation receiving unit 11, a display unit 12, a connection terminal group 13 (connection unit), and the like.

The operation receiving unit 11 includes foot switches P1 to P3 and a foot pedal P4, which have an arrangement and operability that are easy to operate with a foot. In addition, the operation receiving unit 11 includes a power switch P5, a master volume dial P6, a data input dial P7, a patch volume dial P8, and a volume adjustment switch P9, which can be manually operated by the user as necessary such as an operation of setting patch (sound setting) content.

The foot switch P1 is a bank switch, and switches a selection group of patches related to setting of tone, volume, and the like one by one up and down. The foot switch P2 is a number switch, and selects a patch number (here, any of 1 to 4) in the selected bank. That is, the patch is set for each combination of the bank and the number. Note that information of the most recently selected and set patch may be stored in a memory 82 or the like. In this case, even in a case where the power supply of the multi-effector 1 is turned off once and reactivated, the selected patch setting can be continuously used.

The foot switch P3 is a control switch, and can change a set value of a preset effect to a different value according to the operation of the switch.

For example, the foot pedal P4 switches execution or non-execution of a preset effect according to a depression operation by the user, or changes the set value of the effect between two types of preset values.

The power switch P5 is located on a side surface of the multi-effector 1, and alternately switches presence or absence of power supply to an internal configuration of the multi-effector 1 according to an input operation.

The master volume dial P6 can receive a rotation operation around an axis extending in a direction perpendicular to the upper surface (operation surface), and determines a maximum value of the output volume based on each patch or the like according to a rotation position.

The data input dial P7 is rotated when the patch content is created or changed to change the set value of each parameter defined by the patch.

The patch volume dial P8 is for changing the volume (patch volume) set for each of the patches. The set value of the patch volume of the selected patch is increased or decreased according to the rotation operation on the patch volume dial P8.

The volume adjustment switch P9 is pressed to output a start command of volume adjustment processing.

Note that the power switch P5 and the volume adjustment switch P9 may not be push-button switches. For example, the power switch P5 and/or the volume adjustment switch P9 may be a slide switch, a rocker switch, or the like. In addition, the master volume dial P6, the data input dial P7, and the patch volume dial P8 may not receive a dial-like rotation operation. For example, these may be a set of two push-button switches, a slide bar, or the like.

The display unit 12 includes a digital display unit 121, a numerical value display unit 122, a lighting display unit 123, and the like. The digital display unit 121 has a liquid crystal display screen (LCD) and the like, and can display characters, numerical values, figures, signs, and the like on the LCD according to a control signal. In the LCD, a touch panel is positioned to overlap as will be described below.

The numerical value display unit 122 has a segment for displaying a numerical value, and can display a number of three digits here. The segment may be a liquid crystal or an LED. The numerical value display unit 122 can display the selected bank (two digits) and number (one digit: 1 to 4).

The lighting display unit 123 lights the LED according to a status related to the operation and selection. The lighting display unit 123 includes, for example, six LEDs 123a respectively positioned adjacent to the four foot switches P2 and the two foot switches P3, an LED 123b positioned adjacent to the foot pedal P4, and three LEDs 123c indicating statuses related to volume adjustment and patch editing. The three LEDs 123c are positioned side by side with character signs “ADJUSTED”, “EDITED”, and “ERROR”, respectively.

The connection terminal group 13 includes a connection terminal (AC) of a power supply line, a sound signal output terminal (OUT) (here, left and right are separate), a microphone input terminal (MIC IN), and a sound signal input terminal (GUITAR IN) from a musical instrument (guitar). The sound signal that is an electrical signal input from the sound signal input terminal is adjusted in the multi-effector 1. The adjusted sound signal (sound output signal) is output from the sound signal output terminal to a musical instrument amplifier. The sound signal may include a plurality of pitches, and may include a sound of a harmonic string with a characteristic frequency spectral distribution with respect to a sound of a certain pitch.

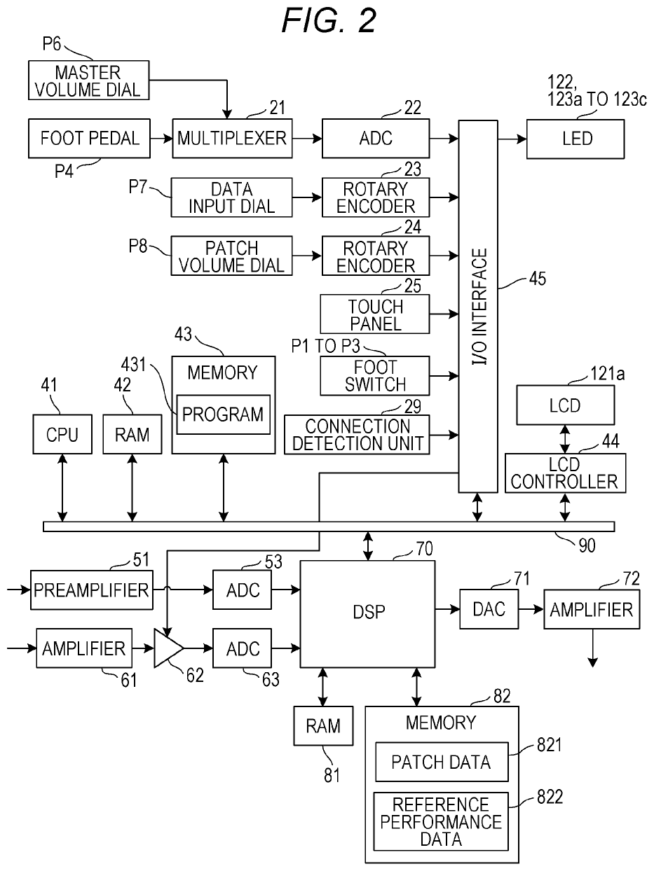

FIG. 2 is a block diagram illustrating a functional configuration of the multi-effector 1.

The multi-effector 1 includes a central processing unit (CPU) 41 (setting acquisition unit), a random access memory (RAM) 42, a memory 43, an LCD controller 44, an input/output (I/O) interface 45, a digital signal processing (DSP) 70 (sound processing unit), and the like, which are connected to a bus 90 and can mutually exchange data.

The CPU 41 is a processor that performs arithmetic processing and integrally controls the multi-effector 1. The CPU 41 may be a single unit, or a plurality of units may operate in parallel or independently according to an application or the like. The CPU 41 is not limited to a general-purpose processor, and may be designed for exclusive use.

The RAM 42 provides the CPU 41 with a working memory space and stores temporary data. The RAM 42 is, for example, a DRAM, but is not limited thereto.

The memory 43 is a nonvolatile memory that stores and holds data. For example, the memory 43 is a flash memory or the like. The memory 43 stores and holds a program 431 executed by the CPU 41.

The LCD controller 44 determines presence or absence of light emission and a light emission amount of each of RGB pixels on the basis of image data to be displayed output from the CPU 41 or the like, and drives the LCD 121a.

The I/O interface 45 acquires an operation reception signal related to detection content directly from each configuration of the operation receiving unit 11 or from a configuration that specifies the operation content received by the each configuration. The I/O interface 45 outputs a drive signal for selectively supplying necessary power to each segment of the LEDs 123a to 123c of the lighting display unit 123 and the numerical value display unit 122. In addition, the I/O interface 45 receives a signal for determining a reception volume (amplitude intensity of the sound signal) of an external microphone from the CPU 41 and outputs the signal to a microphone volume setting unit 62.

A configuration related to detection of an input operation of the operation receiving unit 11 is connected to the I/O interface 45. A rotary encoder 23 detects the rotation amount of the data input dial P7 and outputs a detection result to the I/O interface 45. The rotary encoder 24 detects the rotation amount of the patch volume dial P8 and outputs a detection result to the I/O interface 45. The touch panel 25 is positioned to overlap with the LCD 121a as described above, and outputs information of a touch position to the I/O interface 45 while a touch operation is continued.

When each of the foot switches P1 to P3 is pressed, an operation signal indicating the pressing is output and sent to the I/O interface 45. For example, a detection signal related to the rotation operation of the master volume dial P6 and a detection signal corresponding to the depression operation of the foot pedal P4 are selectively output by a multiplexer 21. The selected and output data is digitally converted by an ADC 22 and sent to the I/O interface 45.

A connection detection unit 29 outputs the detection signal to the I/O interface 45 in a case where a microphone M is connected to the microphone input terminal.

Meanwhile, the multi-effector 1 includes, as a configuration related to sound processing, a preamplifier 51, an analog/digital converter (ADC) 53, an amplifier 61, the above-described microphone volume setting unit 62, an ADC 63, the DSP 70, a digital/analog converter (DAC) 71, an amplifier 72, a RAM 81, a memory 82, and the like.

The preamplifier 51 amplifies the amplitude of the sound signal input from the musical instrument (guitar). The ADC 53 digitally converts the amplified sound signal at an appropriate sampling rate, for example, 44.1 kHz. The obtained digital signal is input to the DSP 70.

The amplifier 61 amplifies the amplitude of the sound signal input from the microphone. As described above, the microphone volume setting unit 62 adjusts the amplitude of the sound signal to a predetermined magnification or ratio according to the control signal input from the CPU 41 via the I/O interface 45. The ADC 63 digitally converts the sound signal adjusted by the microphone volume setting unit 62 at an appropriate sampling rate. The obtained digital signal is input to the DSP 70.

The DSP 70 performs processing (sound processing) of adjusting the digital signal input from the ADC 53 according to the set patch (sound setting) to generate and output a sound signal (sound output signal).

The DSP 70 also performs patch volume correction processing using a sound signal (sound input signal) input from the ADC 63. The RAM 81 is used for the processing of the DSP 70 and stores temporary data. The RAM 81 is, for example, a DRAM. The memory 82 is a nonvolatile memory. The memory 82 stores and holds setting data such as patch data 821 and reference performance data 822 (certain performance data and sound source information) to be used for the processing of the DSP 70, and the like.

The patch data 821 includes the patch (sound setting) which is setting data for specifically setting the pitch, tone, volume, and effect as described above. The patch is stored in association with an identification number (the combination of bank and number) within a settable upper limit number. The patch designated by the input operation to the operation receiving unit 11 is read (acquired) from the patch data 821 and used.

The digital signal adjusted by the DSP 70 is input to the DAC 71 and analog converted. The sound output signal obtained by the analog conversion is amplified by the amplifier 72. The amplified sound output signal is output to an external musical instrument amplifier or the like connected to the sound signal output terminal (OUT).

Next, sound processing according to the patch performed by the DSP 70 will be described.

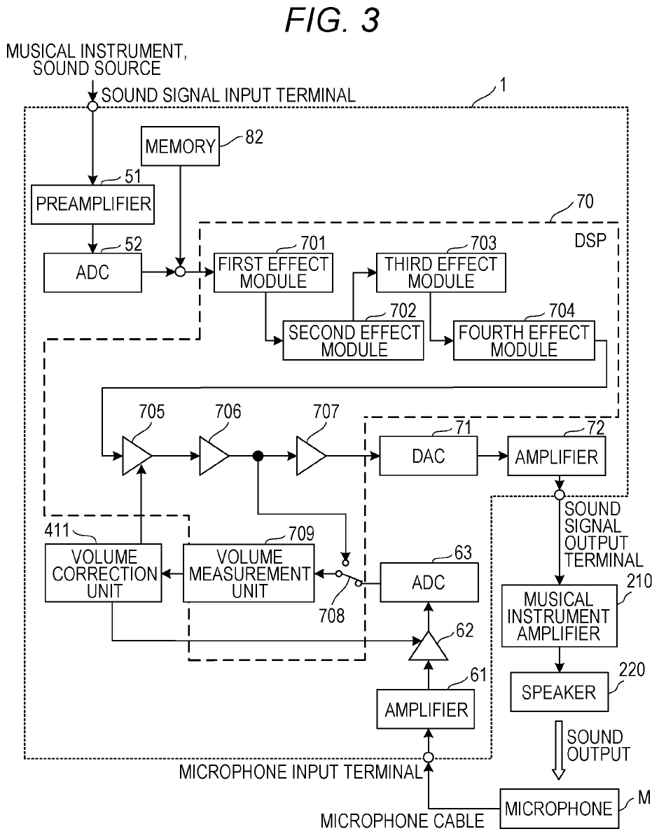

FIG. 3 is a diagram for describing a flow of signals in the DSP 70 and its surroundings;

The DSP 70 includes a first effect module 701, a second effect module 702, a third effect module 703, a fourth effect module 704, a correction volume setting unit 705, a patch volume setting unit 706, a master volume setting unit 707, an input switching unit 708, and a volume measurement unit 709 (volume acquisition unit). Each of these units does not need to have a separate hardware configuration, and some or all of the processing may be executed by a processor common in software. Meanwhile, the processor may be designed and manufactured specifically for the processing to be executed, that is, may not be a general-purpose CPU.

The digital signal digitally converted from the sound signal by the ADC 52 and/or the performance data input from the memory 82 (performance data output unit) are adjusted in sound according to up to four types of effects by the first effect module 701, the second effect module 702, the third effect module 703, and the fourth effect module 704. The type of effect assigned to each of the effect modules 701 to 704 is determined for each patch.

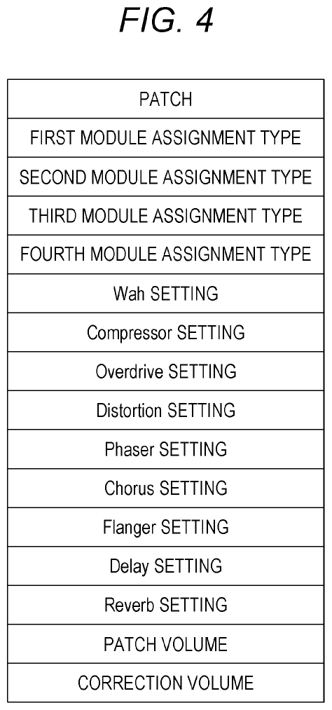

FIG. 4 is a table illustrating an example of setting content related to patch effects. As described above, the patch stores the setting of the type of effect assigned to each of the effect modules 701 to 704 and setting parameters of effect that can be set by the multi-effector 1 regardless of the presence or absence of the assignment. Although not particularly limited, examples of the type of the effect include wah, compressor, overdrive, distortion, phaser, chorus, flanger, delay, and reverb.

Note that, in a case where four effects are not required, “no assignment” may be set to some or all of the effect modules 701 to 704. In the effect module with this setting, the digital signal input without adjustment of the sound signal is output as it is.

In addition, in the patch data, a patch volume (volume) setting related to the output volume and a correction volume (correction amount) setting (correction setting) related to correction of the patch volume are stored for each patch.

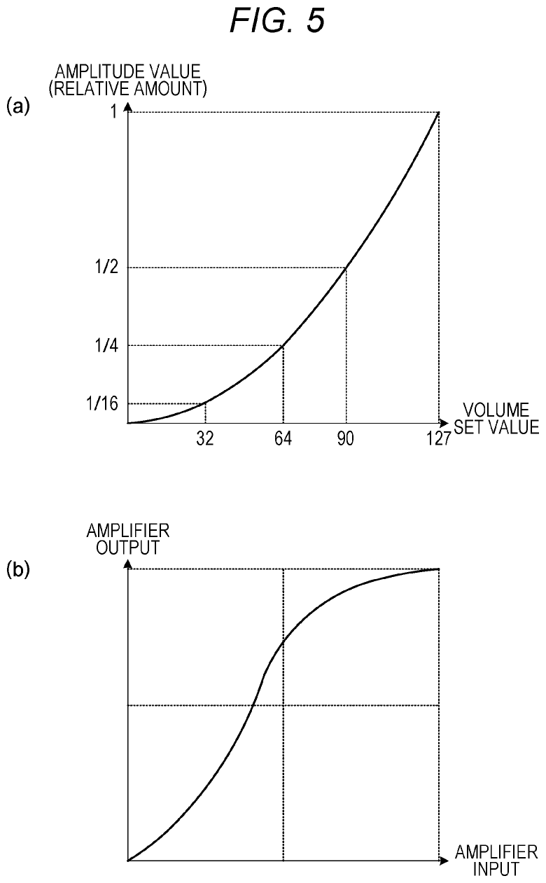

The digital signal output from the fourth effect module 704 is adjusted to the amplitude corresponding to the output volume by the correction volume setting unit 705, the patch volume setting unit 706, and the master volume setting unit 707 (volume setting units 705 to 707 collectively). FIG. 5A is a graph illustrating a relationship between the volume set value and the amplitude. In each of the volume setting units 705 to 707, for example, step setting of 0 to 127 (7 bits) may be performed as a volume value, and a ratio of magnitude of the sound to a reference value (for example, 127 that is the maximum volume) may be determined. This volume value generally corresponds to a square root of the amplitude. Therefore, in each of the volume setting units 705 to 707, the digital signal is adjusted so that the sound output signal having the amplitude corresponding to the volume set value is output.

That is, the volume output from the multi-effector 1 corresponds to a value obtained by multiplying the volume set value of each of the volume setting units 705 to 707. The set value of the patch volume setting unit 706 is included in the patch data as described above. The set value of the master volume setting unit 707 is set in real time by the rotation amount of the master volume dial P6. The correction volume of the correction volume setting unit 705 will be described below.

The digital signal output from the master volume setting unit 707 is input to the DAC 71 as described above. The sound output signal output from the sound signal output terminal (OUT) is output to a musical instrument amplifier 210 (guitar amplifier) and amplified according to characteristics of the musical instrument amplifier 210. The amplified sound output signal is converted into sound by a speaker 220 and output. FIG. 5B is a graph illustrating an example of an input/output relationship in the guitar amplifier. In many cases, the guitar amplifier does not amplify the volume proportional to an input volume setting, and an amplification factor is saturated particularly at a large volume. As a result, a sound unique to the electric guitar is obtained. The musical instrument amplifier 210 and the speaker 220 (collectively, sound output unit) may have an integrated configuration, or different products may be connected by wiring.

The sound output from the speaker 220 may be collected by the microphone M (sound input unit) and converted into an electrical signal (sound input signal). The volume (input volume) of the sound to be input to the microphone M having a microphone cable connected to the microphone input terminal (MIC IN) corresponds to the musical instrument amplifier 210, the speaker 220, and a positional relationship of the microphone M with the speaker 220. The sound input signal obtained by the microphone M is input from the microphone input terminal to the multi-effector 1. The sound input signal is amplified by the amplifier 61, converted (amplification including less than 1 time) to the amplitude set by the microphone volume setting unit 62, and then digitally converted by the ADC 63.

The digital signal obtained by the ADC 63 is input to the volume measurement unit 709. The volume measurement unit 709 obtains an audible volume feeling (loudness) of the sound input signal related to the digital signal. Examples of an evaluation value of the volume feeling (a specific characteristic related to the volume feeling) include loudness units full scale (LUFS) and loudness units (LU). The LUFS is calculated by performing weighted addition (integration) for each frequency by applying an equal loudness curve or the like to a least mean square (RMS) of the amplitude of the sound input signal for each certain period. For example, in human hearing, sensitivity to the sound having a frequency around 3 to 4 kHz is particularly higher than to the sound having other frequencies. Therefore, in the sound of 3 to 4 kHz, the volume feeling (loudness) equal to other frequencies is obtained at a sound pressure level (signal intensity) significantly lower than sounds of other frequencies. The volume measurement unit 709 stores data of the equal loudness curve, for example, list data in which the frequency and the sound pressure level (signal intensity) are associated with each other for each loudness level (volume feeling).

Meanwhile, in the DSP 70, the digital signal output from the patch volume setting unit 706 can be directly input to the volume measurement unit 709 by switching the input switching unit 708. In this case, the input volume does not depend on the musical instrument amplifier 210, the speaker 220, and the positional relationship of the microphone M with the speaker 220. For volume adjustment in a case where recording (recording) is performed, appropriate adjustment can be performed even if the correction volume is set for the digital signal as it is according to the volume feeling instead of the actual sound output. Furthermore, in a case where it is difficult to perform adjustment by actually emitting sound at a live venue, it is possible to reduce a difference in the volume feeling between patches by performing adjustment (volume correction) according to the volume feeling between the digital signals.

A volume correction unit 411 (correction setting unit) can change the setting of the correction volume (ratio/magnification or signal intensity) applied by the correction volume setting unit 705. Furthermore, the volume correction unit 411 (matching setting unit) can change the setting of the ratio/magnification (signal intensity) applied by the microphone volume setting unit 62. These changes can be made on the basis of a measurement result of the volume measurement unit 709. The volume correction unit 411 may be a part of the operation of the CPU 41, or may have a processor separate from the CPU 41.

The processing operation (sound processing step or sound processing means) related to the generation and output of the sound output signal by the DSP 70 may be executed without the control of the CPU 41 or the like. That is, the DSP 70 may mechanically generate and output the sound output signal in a case where the sound signal is input from the sound signal input terminal, converted into the digital signal by the ADC 52, and output, and in a case where the digital signal corresponding to the reference performance data 822 stored in the memory 82 is output.

Next, a control operation of sound output by the multi-effector 1 will be described.

The multi-effector 1 adjusts the input sound signal on the basis of the content set for the patch as described above, and outputs the adjusted sound signal as the sound output signal. Each patch includes a patch volume setting. However, a difference in the auditory volume feeling (loudness) may occur due to a difference in content set for the patch. That is, the total volume feeling differs depending on the pitch of the output sound, the frequency spectral distribution (tone) of the harmonic string, and the like even with the same amplitude.

In the multi-effector 1, setting of the correction volume is added to the patch in order to make the output volume (amplitude) based on each patch more correspond to the auditory volume (the volume corresponding to the volume feeling, loudness). The correction volume is applied to the digital signal by the correction volume setting unit 705. The combination of the correction volume and the patch volume reduces the difference in the volume feeling between patches.

The correction volume is here a parameter (coefficient) to be multiplied to the original patch volume. The correction volume is determined such that the difference between the volume (reference volume) reflecting the above pitch, frequency spectral distribution, and the like and the output volume falls within a reference (satisfies a certain standard and becomes small). The actual output volume may be an assumed value such as the LUFS calculated by applying the equal loudness curve or the like to the least mean square (RMS) of the amplitude according to the patch volume. Alternatively, the output volume may be an actual measurement value obtained by collecting the sound actually output from the amplifier with the microphone M and measuring the volume (the LUFS calculated from a measured value of the amplitude in the above procedure).

The user records reference performance in advance (stores the reference performance as the reference performance data 822 at a certain sampling rate). The reference performance may reflect performance content in a live concert. For example, the reference performance may be an important phrase of a musical piece to be played or may be an arrangement of some chords (chords) frequently used for backing or the like. In the multi-effector 1, the reference performance is reproduced (may be repeated as necessary), and the correction volume setting processing is performed so that the output volume falls within a reference range.

A favorable absolute value of the volume actually output from the amplifier varies depending on the user who performs the performance, the performance (live) venue, and the like. This is set in advance regardless of the patch by the main volume, volume setting (amplification factor) of the musical instrument amplifier 210, and the like.

Next, a reference (reference patch) among the volume adjustment target patches is applied to the reference performance, and only the volume related to the patch volume setting is changed to a settable maximum volume and output. The sound output from the speaker 220 according to the output is collected by the microphone M, amplified, and digitally converted into the digital signal. The volume setting (signal intensity of the sound input signal) in the microphone volume setting unit 62 is adjusted such that the amplitude of the digital signal falls within the reference range from the maximum value (own maximum acquirable volume) of a volume measurement range of the volume measurement unit 709. As a result, matching between the output volume and the input volume is achieved. The sound collection by the microphone M depends on conditions such as the positional relationship between the microphone M and the speaker 220, directivity and direction of the microphone M, and sensitivity of the microphone M. Therefore, the reference performance with the maximum patch volume output from the speaker 220 is adjusted so as to be actually measured as the maximum volume by the volume measurement unit 709 in this manner. As a result, a measured volume with respect to the output at the patch volume set in the patch in the arbitrary patch to be adjusted is relatively determined with respect to the maximum volume of the reference patch.

The reference patch can be, for example, the patch used in the most important performance scene in the live concert, the patch used at the beginning of the live concert, or the like. The reference patch may be arbitrarily selected from the patches used in the live concert.

Information (microphone volume setting) of the maximum volume of the reference patch set once is held in the memory 82 as it is. In the case where the information of the maximum volume is held in the memory 82, the information setting (update) of the maximum volume is not performed when the volume of another patch is adjusted. The information of the maximum volume of the reference patch needs to be reset in a case where the setting content of the reference patch is edited (changed), in a case where the reference patch is changed to another patch according to the musical piece or the like, in a case where the musical instrument amplifier 210 is reset in accordance with a different performance venue, or the like. The stored information of the reference patch is erased according to a predetermined input operation to the operation receiving unit 11. A flag indicating that this information is unavailable may be separately set in addition to or instead of erasing the information of the reference patch. The flag may not be a dedicated binary flag. For example, when the microphone volume is set to a value that cannot be actually set (for example, “A”), it may be indicated that the information of the maximum volume is unavailable (update required). The information of the maximum volume of the reference patch is set in a case where the volume adjustment switch P9 is operated in a situation where the information of the reference patch is not held (a situation where the flag is set).

Alternatively, whether to reset the information of the maximum volume of the reference patch may be determined by an operation mode (for example, a long press for a reference time or longer, or the like) of the volume adjustment switch P9. In this case, the previous information of the maximum volume stored in the memory 82 may be overwritten and updated with the reset information of the maximum volume.

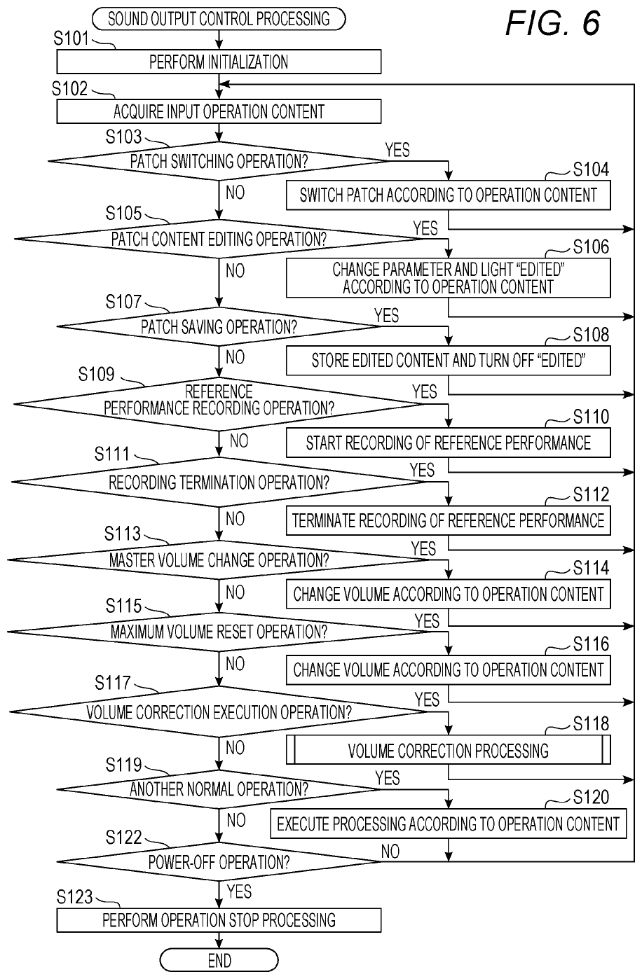

FIG. 6 is a flowchart illustrating a control procedure by the CPU 41 of sound output control processing executed by the multi-effector 1. The sound output control processing is read from the program 431 and activated when the power switch P5 is turned on, and is continuously executed until the power switch P5 accepts an off operation and termination processing is performed. Note that, in the multi-effector 1, various types of processing related to the operation can be continuously executed, but here, processing other than volume control is appropriately omitted or simplified.

When the sound output control processing is started, the CPU 41 initializes various setting parameters and the like (step S101). The CPU 41 waits for the input operation to the operation receiving unit 11 and acquires the content of the input operation (step S102).

The CPU 41 determines whether the acquired input operation is a patch switching operation to the foot switches P1 and P2, the foot pedal P4, or the like (step S103). In a case where it is determined that the input operation is the patch switching operation (“YES” in step S103), the CPU 41 switches the setting to the patch according to the acquired operation content (step S104; setting acquisition step or setting acquisition means). The CPU 41 reads the setting data of the patch of the bank and the number selected from the patch data 821 of the memory 82, and sets the setting data in a register or the like of each unit of the DSP 70. The processing of the CPU 41 returns to step S102.

In a case where it is determined that the input operation is not the patch switching operation (“NO” in step S103), the CPU 41 determines whether the content of the input operation is a patch content editing operation for the data input dial P7 or the patch volume dial P8 (step S105). In a case where it is determined that the input operation is the patch content editing operation (“YES” in step S105), the CPU 41 temporarily updates the content of the patch of the currently selected bank and number according to editing content (step S106). At this time, the CPU 41 notifies that the content of the currently set patch is being edited by lighting the LED corresponding to the sign “EDITED” among the LEDs 123c of the lighting display unit 123. The temporary update here means a change of the set value of the register of each unit of the DSP 70, and update information may be temporarily stored and held in the RAM 81 or the like. Meanwhile, the temporary update does not include updating and saving the patch data 821 in the memory 82. The processing of the CPU 41 returns to step S102.

In a case where it is determined that the input operation is not the patch content editing operation (“NO” in step S105), the CPU 41 determines whether the input operation is a patch saving operation (step S107). The patch saving operation may be received by, for example, an input operation to the touch panel 25 according to display content of the LCD 121a. In a case where it is determined that the input operation is the patch saving operation (“YES” in step S107), the CPU 41 overwrites the setting data of the corresponding patch of the patch data 821 with the set value of the register of each unit of the DSP 70 and stores the set value on the basis of the processing of step S106 (step S108). At this time, the CPU 41 turns off the LED 123c corresponding to the sign “EDITED”. The processing of the CPU 41 returns to step S102.

In a case where it is determined that the input operation is not the patch saving operation (“NO” in step S107), the CPU 41 determines whether the input operation is an operation related to start of recording the reference performance (step S109). The operation related to start of recording the reference performance may be received by, for example, an input operation to the touch panel 25 according to the display content of the LCD 121a. In a case where it is determined that the input operation is the operation related to start of recording the reference performance (“YES” in step S109), the CPU 41 starts the operation (recording) of converting the output from the master volume setting unit 707 of the reference performance into data at a predetermined sampling rate and storing the data in the memory 82 (step S110). The processing of the CPU 41 returns to step S102.

In a case where it is determined that the input operation is not the operation related to start of recording the reference performance (“NO” in step S109), the CPU 41 determines whether the input operation is an operation related to termination of recording the reference performance (step S111). The operation related to termination of recording the reference performance may be received by, for example, an input operation to the touch panel 25 according to the content displayed on the LCD 121a during the recording of the reference performance. In a case where it is determined that the input operation is the operation related to termination of recording the reference performance (“YES” in step S111), the CPU 41 stops the recording (step S112). The processing of the CPU 41 returns to step S102.

In a case where it is determined that the input operation is not the operation related to termination of recording the reference performance (“NO” in step S111), the CPU 41 determines whether the input operation is an operation to change the master volume (step S113). The operation to change the master volume is performed by the rotation of the master volume dial P6. In a case where it is determined that the input operation is the operation to change the master volume (“YES” in step S113), the CPU 41 changes the set value of the master volume according to the content of the change operation (step S114). The processing of the CPU 41 returns to step S102.

In a case where it is determined that the input operation is not the operation to change the master volume (“NO” in step S113), the CPU 41 determines whether the input operation is an operation to reset the maximum volume setting of the reference patch (step S115). In a case where it is determined that the input operation is the operation to reset the maximum volume setting of the reference patch (“YES” in step S115), the CPU 41 initializes the maximum volume setting stored in the memory 82 (step S116). The processing of the CPU 41 returns to step S102.

In a case where it is determined that the input operation is not the operation to reset the maximum volume setting of the reference patch (“NO” in step S115), the CPU 41 determines whether the input operation is an operation related to an execution command of volume correction (step S117). The execution command of volume correction is based on the operation to press the volume adjustment switch P9. In a case where it is determined that the input operation is the operation related to the execution command of volume correction (“YES” in step S117), the CPU 41 calls and executes volume correction processing (step S118). The processing of the CPU 41 returns to step S102.

In a case where it is determined that the input operation is not the operation related to the execution command of volume correction (“NO” in step S117), the CPU 41 determines whether the input operation is another normal operation (step S119). As described above, the another normal operation may include various types of processing not related to the volume control. In a case where it is determined that the input operation is another normal operation (“YES” in step S119), the CPU 41 executes processing according to the content of the another normal operation (step S120). The processing of the CPU 41 returns to step S102.

In a case where it is determined that the input operation is not another normal operation (“NO” in step S119), the CPU 41 determines whether the input operation is a power-off operation (step S122). The power-off operation is an operation of the power switch P5. In a case where it is determined that the input operation is not the power-off operation (“NO” in step S122), the processing of the CPU 41 returns to step S102. In a case where it is determined that the input operation is the power-off operation (“YES” in step S122), the CPU 41 performs processing related to operation stop of the multi-effector 1 (step S123). The processing related to operation stop can include, for example, stop of access to the memories 43 and 82. Then, the CPU 41 terminates the sound output control processing.

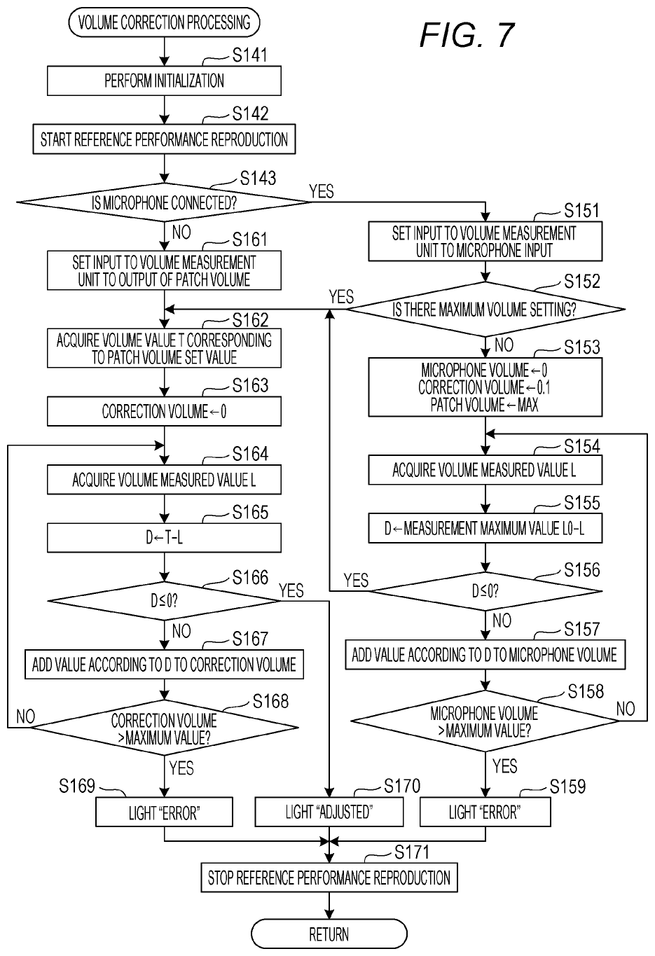

FIG. 7 is a flowchart illustrating a control procedure of volume correction processing called in step S118 of the sound output control processing including a volume control method of the present embodiment.

When the volume correction processing is started, the CPU 41 initializes variable parameters and the like (allocates a memory area and performs resetting) (step S141). The CPU 41 reads the reference performance data 822 from the memory 82 and starts reproduction of the reference performance (step S142). Note that, at the time of reproduction, the reference performance data 822 is copied to the RAM 81 and sequentially converted into the digital signal. As described above, in a case where the reproduction of the reference performance ends before the processing of step S171, the CPU 41 repeats the reproduction of the reference performance from the beginning.

The CPU 41 determines whether connection of the microphone M to the microphone input terminal has been detected (step S143). The presence or absence of connection of the microphone M is determined on the basis of the detection signal from the connection detection unit 29.

In a case where it is determined that the microphone M is connected to the microphone input terminal (“YES” in step S143), the CPU 41 switches and sets the input switching unit 708 so that the input to the volume measurement unit 709 is set to the microphone input (ADC 63) (step S151).

The CPU 41 determines whether the setting of the maximum volume of the valid reference patch is stored in the memory 82 (step S152). In a case where it is determined that the setting of the maximum volume of the valid reference patch is stored in the memory 82 (“YES” in step S152), the processing of the CPU 41 proceeds to step S162.

In a case where it is determined that the setting of the maximum volume of the valid reference patch is not stored in the memory 82 (“NO” in step S152), the CPU 41 sets the volume set value of the microphone volume setting unit 62 to 0, sets the correction volume of the correction volume setting unit 705 to 1.0 time (reference value), and sets the patch volume to the maximum value (127 or the like) (step S153).

The CPU 41 acquires a volume measured value L from the volume measurement unit 709 (step S154). As described above, the absolute value of the volume may be a different value depending on the master volume, the setting of the musical instrument amplifier 210, and the like. The CPU 41 obtains a difference D obtained by subtracting the volume measured value L from a detection maximum value LO of the volume measurement unit 709 (step S155).

The CPU 41 determines whether the difference D is equal to or less than “0” (step S156). In a case where it is determined that the difference D is “0” or less (within the reference range) (“YES” in step S156), the processing of the CPU 41 proceeds to step S162. This situation corresponds to a state in which the microphone volume is adjusted so that the volume measured value by the volume measurement unit 709 becomes the maximum corresponding to the volume of a case where the patch volume is the maximum. At this time, the CPU 41 stores identification information of the reference patch and information of the set value of the maximum volume in the reference patch in the memory 82.

In a case where it is determined that the difference D is not equal to or less than “0” (“NO” in step S156), the CPU 41 adds a value having magnitude corresponding to the difference D to the microphone's volume set value (step S157). The value (change amount) corresponding to the difference D is a value determined in advance so as to decrease as the difference D decreases. When a constant addition value corresponding to matching accuracy between the detection maximum value LO and the volume measured value L is added to the volume set value every time, it takes a lot of time for the volume measured value L to reach the detection maximum value LO. Therefore, the volume set value of the microphone is greatly changed to approach the detection maximum value LO at once while the difference D is large. The volume measured value L is caused to asymptotically approach the detection maximum value LO by reducing the change amount accordingly when the difference D decreases, so that an accurate volume set value of the microphone is efficiently obtained.

The CPU 41 determines whether the microphone's volume set value is larger than the maximum value settable by the microphone volume setting unit 62 (step S158). In a case where it is determined that the volume set value is not larger than the maximum value (equal to or less than the maximum value) (“NO” in step S158), the processing of the CPU 41 returns to step S154. In a case where it is determined that the volume set value is larger than the maximum value (“YES” in step S158), the CPU 41 turns on the LED 123c corresponding to the sign “ERROR” among the LEDs 123c (step S159). Examples of a cause of not obtaining a sufficient volume measured value include the main volume being too low, the output volume of the amplifier being too low, and the position or orientation of the microphone M being inappropriate. In such a case, the user needs to readjust these cases. The CPU 41 stops the reproduction of the reference performance (step S171). Then, the CPU 41 terminates the volume correction processing and returns the processing to the sound output control processing.

In the case where it is determined that the microphone M is not connected to the microphone input terminal in the determination processing of step S143 (“NO” in step S143), the CPU 41 switches the input switching unit 708 so that the input to the volume measurement unit 709 is set to the output of the patch volume setting unit 706 (step S161). The processing of the CPU 41 proceeds to step S162.

When the processing proceeds from the determination processing of steps S152 and S156 or the processing of step S161 to the processing of step S162, the CPU 41 acquires a volume value T corresponding to the patch volume set value of the set patch. The CPU 41 sets the set value of the correction volume to 0 (step S163).

The CPU 41 acquires the volume measured value L obtained by measuring, by the volume measurement unit 709, the digital signal input from the microphone M or the patch volume setting unit 706 to the volume measurement unit 709 according to the reproduction of the reference performance (step S164). The CPU 41 calculates the difference D obtained by subtracting the volume measured value L from the volume value T (step S165).

The CPU 41 determines whether the difference D is equal to or less than 0 (step S166). In a case where it is determined that the difference D is equal to or less than 0 (within the reference range) (“YES” in step S166), the CPU 41 turns on the LED 123c corresponding to the sign “ADJUSTED” (step S170). Similarly to the processing of step S156, the absolute value of the difference D becomes the minimum before and after the point where the difference D becomes equal to or less than 0, and the volume measured value L becomes closest to the volume value T. The CPU 41 stores the correction volume at this time in the patch setting data as the set value of the correction volume. The processing of the CPU 41 proceeds to step S171.

In a case where it is determined that the difference D is not equal to or less than (larger than 0) (“NO” in step S166), the CPU 41 adds the value corresponding to the magnitude of the difference D to the correction volume (step S167). Similarly to step S157, the value to be added (change amount) is set to be smaller as the difference D is smaller. Therefore, it is possible to cause the volume measured value L to quickly approach the volume value T by adding a large addition value while the difference D is large. Then, when the difference D decreases, the change amount is gradually reduced so that the volume measured value L gradually (asymptotically) approaches the volume value T. By setting such a change amount, the correction volume is quickly and accurately specified.

The CPU 41 determines whether the correction volume is larger than a measurement maximum value of the volume measurement unit 709 (step S168). In a case where it is determined that the correction volume is not larger than (is equal to or less than) the measurement maximum value (“NO” in step S168), the processing of the CPU 41 returns to step S164.

In a case where it is determined that the correction volume is larger than the measurement maximum value (“YES” in step S168), the CPU 41 turns on the LED 123c corresponding to the sign “ERROR” among the LEDs 123c (step S169). In a case where the desired volume measured value L cannot be obtained with the patch having the volume feeling significantly smaller than the reference patch or the like, the setting of the patch itself needs to be corrected. Therefore, such a state is notified to the user by turning on the LED 123c corresponding to the sign “ERROR”. The processing of the CPU 41 proceeds to step S171.

### Second Embodiment

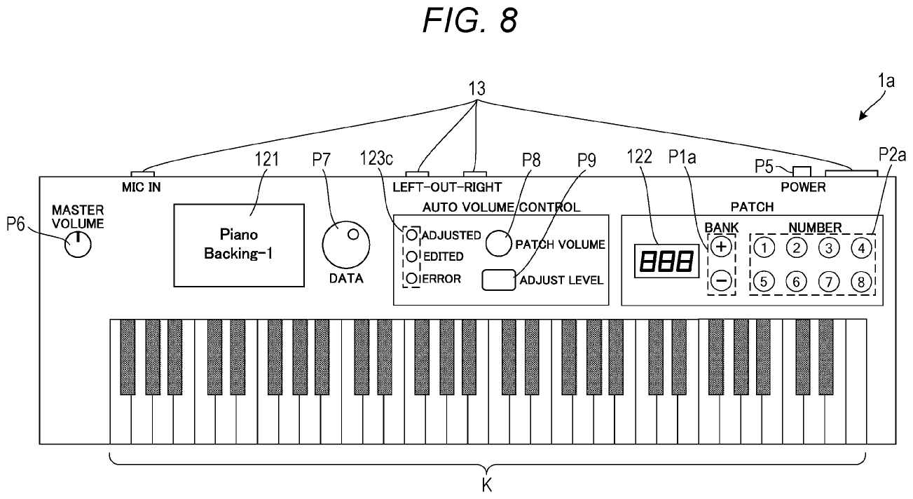

FIG. 8 is a plan view illustrating an upper surface of an electronic musical instrument 1a including a volume control device of a second embodiment.

The electronic musical instrument 1a is a keyboard instrument (keyboard) in which a configuration of a musical instrument portion as a sound source and a configuration as the above-described multi-effector are integrated.

In the electronic musical instrument 1a, a keyboard K is added to each configuration of the above-described multi-effector 1, and LEDs 123a and 123b, and foot switch P3 and foot pedal P4 are omitted. In addition, the electronic musical instrument 1a does not include a sound signal input terminal in a connection terminal group 13. The foot switches P1 and P2 are replaced with switches P1a and P2a to be pressed with a hand (finger), respectively. Here, the switch P2a includes eight switches corresponding to numbers 1 to 8. Other configurations are the same, and the same configurations are denoted by the same reference numerals, and description thereof is omitted.

Note that the electronic musical instrument 1a may have a foot pedal (sound pedal) (not illustrated). Further, the foot pedal may be externally attached to the electronic musical instrument 1a. Along with this or regardless of whether the foot pedal can be externally attached, the electronic musical instrument 1a may have a sound signal input terminal.

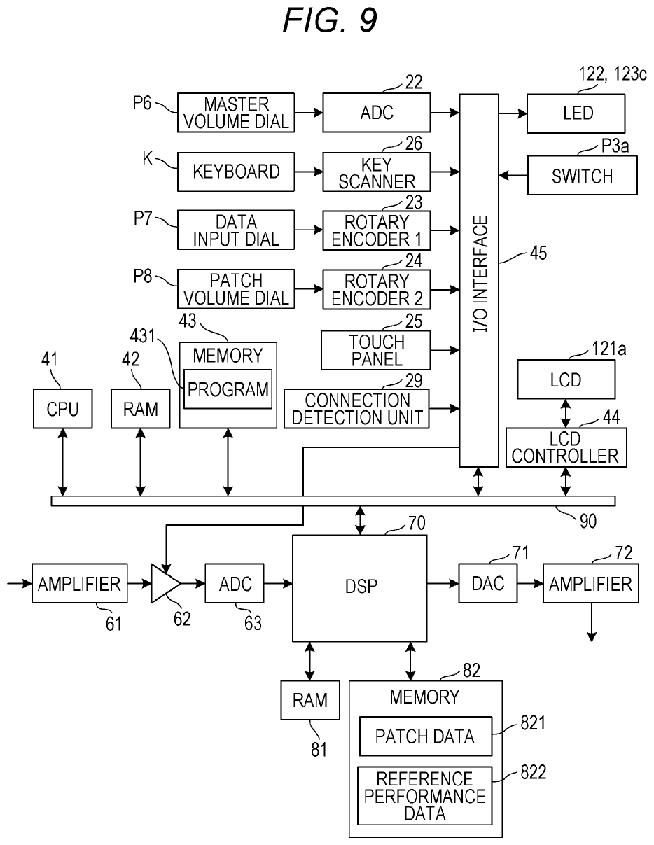

FIG. 9 is a block diagram illustrating a functional configuration of the electronic musical instrument 1a.

The keyboard K is connected to an I/O interface 45 via a key scanner 26 that detects an operation of each key of the keyboard K. A preamplifier 51 and an ADC 53 are omitted with the omission of the sound signal input terminal. Further, as described above, the foot pedal P4 is omitted, and accordingly, an operation reception signal of a master volume dial P6 is input to an ADC 22 without passing through a multiplexer 21. A switch P3a, instead of the foot switch P3, is connected to the I/O interface 45. Other configurations are the same as those of the multi-effector 1 of the first embodiment, and the same components are denoted by the same reference numerals, and description thereof is omitted.

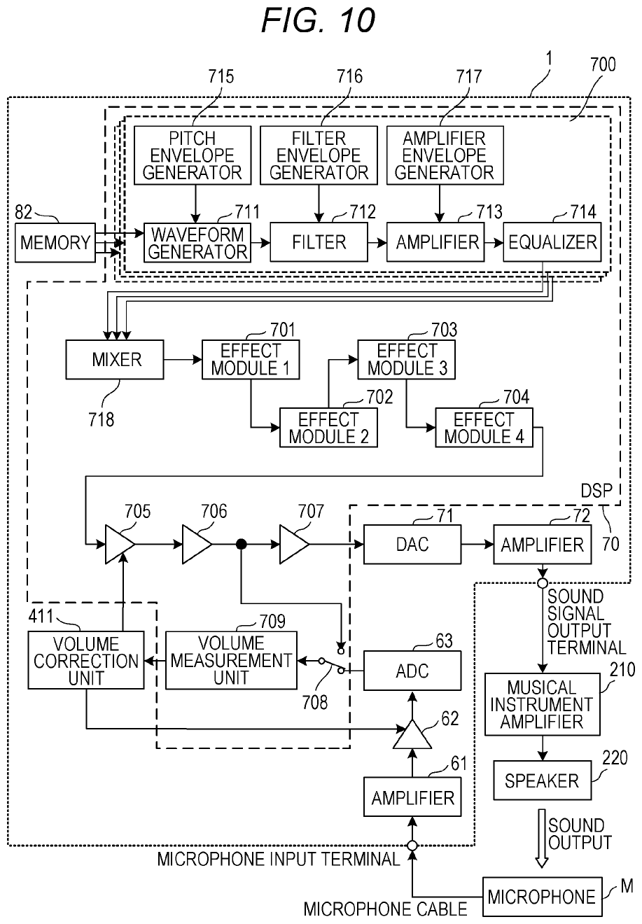

FIG. 10 is a diagram for describing a flow of signals in the electronic musical instrument 1a.

The electronic musical instrument 1a generates a corresponding sound at generation timing of each sound on the basis of reference performance data 822 (certain performance data and sound source information) stored in a memory 82. In the present embodiment, the reference performance data 822 is MIDI data. A DSP 70 includes a sound generation unit 700. The sound generation unit 700 can generate simultaneously emitted sounds in parallel within a range of a maximum set number (sixty-four sounds, for example, although three sounds are illustrated in FIG. 10). The generated sounds are synthesized by a mixer 718 and sent to a first effect module 701.

Each sound generation unit 700 includes a waveform generator 711, a filter 712, an amplifier 713, an equalizer 714, a pitch envelope generator 715, a filter envelope generator 716, and an amplifier envelope generator 717. The waveform generator 711 generates a signal having a frequency corresponding to a pitch of the sound to be generated. The pitch envelope generator 715 defines change patterns of a temporal rise (attack), continuation (sustain), a transition from a rise peak to continuation (delay), and a fall (release) after the end of key depression, of a frequency signal to be generated. For example, in a case where a sound corresponding to a keyboard instrument such as a piano or an organ is output, the pitch is set so as not to change until the sound is lost after the key is pressed.

The filter 712 defines a tone of the generated sound of the frequency. The tone is determined according to a distribution of frequency spectral intensity and the like. The frequency spectral intensity and the like have generally a characteristic shape depending on a musical instrument. In the electronic musical instrument, various distribution shapes of frequency spectral intensity can be set. The filter envelope generator 716 defines a temporal change in the tone. In particular, in the sound rise, there may be specific changes in the tone depending on a musical instrument, and these can be set by the filter envelope generator 716.

The amplifier 713 determines a volume of the sound with the generated pitch and tone. The amplifier envelope generator 717 defines a temporal change in the volume of each sound to be generated over each period (ADSR). In a case where there is no duration like a piano or the like, it is also possible to attenuate the volume to a silent state according to the fall regardless of the continuous state of pressing of the key.

Output settings of each sound in which the pitch, tone, and volume in each stage of attack, sustain, delay, and release are defined by the waveform generator 711, the filter 712, and the amplifier 713 are stored in a patch together with the setting related to the frequency spectral distribution adjustment by the equalizer 714 and settings of various effects described in the multi-effector 1. As a result, the sound according to the selected patch can be easily and variously output.

As described above, even for the reference performance generated on the basis of MIDI data or the like, the volume can be adjusted by the same processing as the processing illustrated in FIGS. 6 and 7 of the above-described embodiment. The MIDI data may be generated from performance data based on an operation of the keyboard K, or externally generated data may be acquired.

As described above, the multi-effector 1 and the electronic musical instrument 1a including the volume control device of the present embodiment include a CPU 41 and the DSP 70. The CPU 41 acquires the sound setting (patch) related to sound output based on the sound source information (reference performance data 822) as a setting acquisition unit. The DSP 70 generates a sound output signal from the acquired sound source information on the basis of the patch. The patch includes a volume setting that defines a patch volume and a correction setting related to a correction volume of the volume according to a volume feeling of the patch. The DSP 70 corrects the volume set in the volume setting with the correction volume to generate the sound output signal.

As described above, by correcting the patch volume with the correction volume according to the volume feeling across various patches, it is possible to suppress a change in the volume feeling in a case where the patch is switched to a different patch. That is, the multi-effector 1 and the electronic musical instrument 1a can more easily output sound with an appropriate volume feeling. Therefore, by using this volume control device, a user can suppress a sense of discomfort caused by the change in the volume feeling at the time of switching a plurality of patches, and can adjust a performance effect to what the user desires with higher accuracy. In addition, the user does not need to switch a master volume and an output of a musical instrument amplifier 210 every time the patch is switched.

In addition, the multi-effector 1 and the electronic musical instrument 1a include the memory 82 as a performance data output unit that stores and outputs the reference performance data as the sound source information, a volume measurement unit 709 that acquires an output volume by the sound output signal generated by the DSP 70 on the basis of the reference performance data and the patch on the basis of a certain characteristic (for example, LUFS) related to the volume feeling, and a volume correction unit 411 that determines the correction volume so that a difference D between an output volume and a reference volume based on the certain characteristic satisfies a certain standard and becomes small, and includes the correction volume in the patch as the correction setting.

As described above, the multi-effector 1 and the electronic musical instrument 1a can correct the sound output signal by the patch volume by the output volume uniformly obtained on the basis of the volume feeling. Therefore, it is possible to suppress feeling of a sense that the auditory volume changes according to the sound settings such as the pitch and tone defined in the patch.

Further, the volume correction unit 411 may cause the volume measurement unit 709 to acquire the output volume while changing the correction amount with a smaller change amount as the difference D is smaller, and may asymptotically specify the correction volume with which the difference D satisfies the standard.

With such a method of determining the change amount, the multi-effector 1 and the electronic musical instrument 1a can efficiently and quickly specify the correction volume with high accuracy.

Further, the multi-effector 1 and the electronic musical instrument 1a include a connection terminal group 13. The connection terminal group 13 includes a sound signal output terminal that causes a sound output unit (the musical instrument amplifier 210 and the speaker 220) capable of performing sound output according to the sound output signal to output a sound output signal, and a microphone input terminal that causes a microphone M to input a sound input signal, which has been obtained by the microphone M that collects a sound and converts the sound into the sound input signal. The volume measurement unit 709 acquires the output volume on the basis of a result of measurement of an input volume of the sound input signal, which has been obtained by the microphone M that collects the sound output.

As described above, a sound is once output by the speaker 220 on the basis of the sound output signal generated by the multi-effector 1 or the electronic musical instrument 1a. Then, the sound output is collected by the microphone M and acquired as the sound input signal and measured as the input volume, and an actual output volume is acquired on the basis of the input volume. As a result, in the multi-effector 1 and the electronic musical instrument 1a can easily perform optimum volume setting in accordance with an actual volume feeling in a like venue or the like.

Further, the volume correction unit 411 operates as a matching setting unit. The volume correction unit 411 as the matching setting unit changes the volume defined by the volume setting in the reference patch to a maximum volume settable in the volume setting, and causes the sound output unit to output the sound output signal based on the reference performance data 822 from the sound signal output terminal. The volume correction unit 411 causes the volume measurement unit 709 to measure the input volume of the sound input signal related to the sound output obtained by the microphone M. Then, the volume correction unit 411 causes the input volume to match the output volume by determining signal intensity of the sound input signal by a microphone volume setting unit 62 such that the difference D between the input volume and its own maximum acquirable volume falls within a reference range. An absolute value of the volume actually output in a live venue or the like varies depending on a master volume by the user, the output of the musical instrument amplifier 210, and the like. Therefore, a reference volume is required to equalize the volume feeling between patches. The multi-effector 1 and the electronic musical instrument 1a perform matching adjustment so that the volume measurement unit 709 can acquire the maximum volume by the setting of any reference patch as the reference volume (maximum volume). As a result, the measured value of the input volume corresponding to the set volume of the arbitrary patch is evaluated relatively to the reference volume, and the volume correction unit 411 can appropriately determine the correction volume.

Further, the volume correction unit 411 acquires the patch to be adjusted and causes the sound output unit to output the sound output signal based on the reference performance data from the sound signal output terminal. The volume correction unit 411 causes the volume measurement unit 709 to acquire the output volume on the basis of a result of measurement in which the input volume of the sound input signal related to the sound output obtained by the microphone M has been matched. Then, the volume correction unit 411 determines the correction volume related to the patch to be adjusted on the basis of the acquired output volume.

As described above, the volume based on the volume feeling of each patch can be appropriately obtained on a unified basis by the output volume acquired by the volume measurement unit 709 after the matching adjustment. As a result, in the multi-effector 1 and the electronic musical instrument 1a, the volume correction unit 411 can appropriately determine the correction volume.

Further, the correction volume may be a coefficient that is multiplied with the volume set in the volume setting of the patch. The coefficient to be multiplied is more suitable and easier to use for adjusting a ratio to the reference volume than addition/subtraction values or the like.

In addition, a specific characteristic related to the volume feeling may be LUFS. Among the currently used characteristics, the LUFS has a relatively high degree of appropriately reflecting the volume feeling. Therefore, by acquiring the output volume using the LUFS and using the output volume to determine the correction volume, it is possible to more appropriately suppress an auditory sense of discomfort felt by the user or an audience in a case where the patch is switched in a live concert.

Further, the electronic musical instrument 1a has a functional configuration as the above-described volume control device. Therefore, the patch can be applied with a more appropriate volume feeling as desired at the performance of the electronic musical instrument 1a by the user. Thereby, the performance effect by the electronic musical instrument 1a can be further enhanced.

Further, a volume control method of the present embodiment includes a setting acquisition step of acquiring the patch related to the sound output based on the sound source information (reference performance data 822), and a sound processing step of generating the sound output signal from the acquired reference performance data 822 on the basis of the acquired patch. The patch includes a volume setting that defines the volume and a correction setting related to the correction volume of the volume according to the volume feeling of the sound setting. The sound processing step includes correcting the volume set in the volume setting with the correction volume to generate the sound output signal.

According to the volume control method, the sound output is more easily performed with a more appropriate volume feeling. Therefore, by using the volume control method, the user can suppress the sense of discomfort caused by the change in the volume feeling at the time of switching a plurality of patches, and can adjust the performance effect to what the user desires with higher accuracy.

In addition, by executing a program 431 of the present embodiment in a software manner, the volume control according to the volume control method can be easily and appropriately performed.

Note that the present disclosure is not limited to the above embodiments, and various modifications can be made.

For example, in the first embodiment, the performance by the user is directly recorded, stored as the reference performance data 822, and reproduced, but recorded data may be acquired from an outside.

Further, in the above-described embodiments, the volume is gradually increased from volume 0 to asymptotically approach the reference value and is fixed at the value that has exceeded the reference value at the time of setting the microphone volume and the correction volume by the microphone volume setting unit 62, but the embodiment is not limited thereto. For the microphone volume and the correction volume, a value before or a value after the volume exceeds the reference value, whichever is smaller in the absolute value of the difference D, may be adopted. Alternatively, for example, the input volume may be caused to asymptotically approach the reference value while sandwiching the reference value from both the large and small sides of the volume by inverting positive and negative signs of the change amount in a case where the positive and negative signs of the difference D are inverted.

Furthermore, the volume output and adjusted when the microphone volume is determined may not be the maximum volume as the patch volume and the measured volume by the volume measurement unit 709. The microphone volume may be determined by other patch volume and measured volume.

Further, in the above-described embodiments, the musical instrument amplifier 210 and the speaker 220 may not be separate from the electronic musical instrument 1a and the like. That is, these elements may be built in the electronic musical instrument 1a.

Further, the musical instrument is line-connected with the musical instrument amplifier 210 and the microphone M via the connection terminal group 13, but the embodiment is not limited thereto. They may be wirelessly connected via wireless communication. The wireless communication is not particularly limited as long as necessary data transmission speed can be obtained. For example, the wireless communication may be any near field communication with a transmittable distance of about several meters to several tens of meters.

Further, in the above-described embodiments, the volume measurement unit 709 has been described as a configuration of the DSP 70 and the volume correction unit 411 has been described as a configuration outside the DSP 70, but the embodiment is not limited thereto. Each of them may be configured inside the DSP 70, or on the contrary, each of them may be configured outside the DSP 70.

Furthermore, in the above-described embodiments, the keyboard instrument (keyboard) and the guitar have been described as examples of the electronic musical instrument, but the electronic musical instrument is not limited thereto. The electronic musical instrument may be another musical instrument, for example, a wind instrument or the like.

Further, the patch including the correction volume set by another multi-effector, the electronic musical instrument, or the like may be simply used by another device. Note that the master volume, the microphone volume, and the like are naturally different between different devices. In addition, in a case where different musical instrument amplifiers 210 are used, characteristics of the instrument amplifiers are also different. Therefore, in the case where the microphone volume and the correction volume are determined by collecting the sound output with the microphone, it is more favorable to reset the microphone volume and the correction volume again in another device.

Further, in the above description, the memory 43 including a nonvolatile memory such as an HDD or a flash memory has been described as an example of a computer-readable medium storing the program 431 related to the volume adjustment control of the present disclosure, but the embodiment is not limited thereto. As another computer-readable medium, another nonvolatile memory such as an MRAM or a portable recording medium such as a CD-ROM or a DVD disk can be applied. Further, as a medium for providing data of the program according to the present disclosure via a communication line, a carrier wave is also applied to the present disclosure.

In addition, the specific configuration, and content and procedures of the processing operation, and the like described in the above embodiments can be appropriately changed without departing from the gist of the present disclosure.

Specific embodiments of the present disclosure were described above, but the present disclosure is not limited to the above embodiments, and modifications, improvements, and the like within the scope of the aims of the present disclosure are included in the present disclosure. It will be apparent to those skilled in the art that various modification and variations can be made in the present disclosure without departing from the spirit or scope of the disclosure. Thus, it is intended that the present disclosure cover modifications and variations that come within the scope of the appended claims and their equivalents. In particular, it is explicitly contemplated that any part or whole of any two or more of the embodiments and their modifications described above can be combined and regarded within the scope of the present disclosure.

What is claimed is:

1. A volume control device comprising at least one information processor configured to:
acquire a sound setting related to a sound output based on sound source information; and
generate a sound output signal from the acquired sound source information on the basis of the sound setting, wherein
the sound setting includes a volume setting that defines a volume and a correction setting related to a correction amount of the volume according to a volume feeling of the sound setting, and
the information processor is further configured to correct the volume defined in the volume setting with the correction amount to generate the sound output signal.

2. The volume control device according to claim 1,
wherein the information processor is further configured to:
output certain performance data as the sound source information;
acquire, on the basis of a specific characteristic related to the volume feeling, an output volume by the sound output signal generated on the basis of the performance data and the sound setting; and
determine the correction amount so that a difference between the output volume and a reference volume based on the specific characteristic satisfies a certain standard and becomes small, and includes the correction amount in the sound setting as the correction setting.

3. The volume control device according to claim 2,
wherein the information processor is further configured to acquire the output volume while changing the correction amount with a smaller change amount as the difference is smaller, and asymptotically specify the correction amount with which the difference satisfies the standard.

4. The volume control device according to claim 2, further comprising:
a connection unit configured to cause a sound output unit capable of performing sound output according to the sound output signal to output the sound output signal, and cause a sound input unit to input a sound input signal that has been obtained by the sound input unit that collects a sound and converts the sound into the sound input signal,
wherein the information processor is further configured to
acquire the output volume on the basis of a result of measurement of an input volume of the sound input signal obtained by the sound input unit that has collected the sound output.

5. The volume control device according to claim 4,
wherein the information processor is further configured to:
change the volume defined by the volume setting in the sound setting serving as a reference to a maximum volume settable in the volume setting, and cause the connection unit to cause the sound output unit to output the sound output signal based on the performance data;
cause the input volume of the sound input signal to be measured, the input volume of the sound input signal being related to the sound output obtained by the sound input unit; and
cause the input volume to match the output volume by determining signal intensity of the sound input signal such that a difference between the input volume and a maximum acquirable volume of the information processor falls within a reference range.

6. The volume control device according to claim 5,
wherein the information processor is further configured to:
acquire a sound setting to be adjusted and cause the connection unit to cause the sound output unit to output the sound output signal based on the performance data;
cause the output volume to be acquired on the basis of the result of measurement in which the matching of the input volume of the sound input signal related to the sound output obtained by the sound input unit has been performed; and
determine the correction amount related to the sound setting to be adjusted on the basis of the output volume.

7. The volume control device according to claim 1,
wherein the volume feeling is obtained by measuring
a digital signal obtained by digitally converting the sound signal input from a sound input unit, or
a digital signal input without through the sound input unit.

8. The volume control device according to claim 1, wherein the correction amount is a coefficient that is multiplied with the volume set in the volume setting.

9. The volume control device according to claim 2, wherein the specific characteristic is LUFS.

10. An electronic musical instrument comprising: the volume control device according to claim 1.

11. A volume control method performed by at least one information processor, the volume control method comprising:
setting acquisition processing of acquiring a sound setting related to a sound output based on sound source information; and
sound processing of generating a sound output signal from the acquired sound source information on the basis of the sound setting, wherein
the sound setting includes a volume setting that defines a volume and a correction setting related to a correction amount of the volume according to a volume feeling of the sound setting, and
the sound processing includes correcting the volume defined in the volume setting with the correction amount to generate the sound output signal.

12. The volume control method according to claim 11, further comprising:
volume acquisition processing of acquiring, on the basis of a specific characteristic related to the volume feeling, an output volume by the sound output signal generated on the basis of performance data and the sound setting; and
correction setting processing of determining the correction amount so that a difference between the output volume and a reference volume based on the specific characteristic satisfies a certain standard and becomes small, and includes the correction amount in the sound setting as the correction setting.

13. The volume control method according to claim 12, wherein
the correction setting processing causes the output volume to be acquired by the volume acquisition processing while changing the correction amount with a smaller change amount as the difference is smaller, and asymptotically specifies the correction amount with which the difference satisfies the standard.

14. A non-transitory recording medium storing a program for causing at least one information processor to perform:
setting acquisition processing of acquiring a sound setting related to a sound output based on sound source information; and
sound processing of generating a sound output signal from the acquired sound source information on the basis of the sound setting, wherein
the sound setting includes a volume setting that defines a volume and a correction setting related to a correction amount of the volume according to a volume feeling of the sound setting, and
the sound processing corrects the volume defined in the volume setting with the correction amount to generate the sound output signal.

15. The non-transitory recording medium according to claim 12, for further causing the at least one information processor to perform:
volume acquisition processing of acquiring, on the basis of a specific characteristic related to the volume feeling, an output volume by the sound output signal generated on the basis of performance data and the sound setting; and
correction setting processing of determining the correction amount so that a difference between the output volume and a reference volume based on the specific characteristic satisfies a certain standard and becomes small, and includes the correction amount in the sound setting as the correction setting.

16. The non-transitory recording medium according to claim 14, wherein
the correction setting processing causes the output volume to be acquired by the volume acquisition processing while changing the correction amount with a smaller change amount as the difference is smaller, and asymptotically specifies the correction amount with which the difference satisfies the standard.
